(19) United States
(12) Patent Application Publication
(10) Pub. No.: US 2023/0023481 A1
(43) Pub. Date: Jan. 26, 2023

(54) SYSTEMS AND METHODS FOR CALENDAR AND TASKS MANAGEMENT USER INTERFACE

(71) Applicant: Dror LAVY, Ganei Tikva (IL)

(72) Inventor: Dror LAVY, Ganei Tikva (IL)

(21) Appl. No.: 17/784,506

(22) PCT Filed: Aug. 23, 2020
(86) PCT No.: PCT/IB2020/057890

§ 371 Date: Jun. 10, 2022

Related U.S. Application Data
(60) Provisional application No. 62/929,873, filed on Nov. 3, 2019.

(51) Int. Cl. G06Q 10/10; G06F 3/0486; G06F 3/04817; G06F 3/0485

(52) U.S. Cl. CPC G06Q 10/1097; G06F 3/0486; G06F 3/04817; G06F 3/0485

(57) ABSTRACT

Systems and methods for displaying a calendar and tasks management user interface of a calendar and tasks management application, wherein calendar items and task items are presented without separation, the user interface includes three main segments, representing ‘past’, ‘present’ and ‘future’ and displayed vertically wherein said ‘past’ segment has one connecting point to said ‘present’ segment and wherein said ‘present’ segment has at least one connecting point to said ‘future’ segment.

### BACKGROUND

### 1. Technical Field

Embodiments of the present invention relate generally to systems and methods for calendar and tasks management user interface.

### 2. Description of Related Art

Current days user interfaces for computer managed calendars and tasks are, in most cases, a copy, with minor adaptations, of the old known paper calendar in which people wrote using pen or pencil and this method is very restrictive and one might even say—destructive.

Hence, an improved systems and methods as described in this application are still a long felt need.

### BRIEF SUMMARY

According to an aspect of the present invention a method comprising: at an electronic device with a display, at least one input device, one or more processors and memory storing one or more programs configured to be executed by the one or more processors, the one or more programs including instructions for: displaying a calendar and tasks management user interface 100 of a calendar and tasks management application, wherein calendar items and task items are presented without separation, the user interface includes three main segments, representing ‘past’ 101, ‘present’ 102 and ‘future’ 103 and displayed vertically wherein said ‘past’ segment has one connecting point to said ‘present’ segment and wherein said ‘present’ segment has at least one connecting point to said ‘future’ segment; wherein said ‘future’ segment include more than one item vertically and horizontally arranged according to user's definition with or without due date or time assignment; wherein said items presented at the end of a branch like representation originated from said connection to said ‘present’ segment; further wherein the representation of an item would be presented higher for item scheduled to future date or less important than the item beneath it; further wherein two icons are presented next to each item, representing buttons for deletion of the item and to reassigning of the item to the ‘present’ segment; and wherein said representation of an item may be dragged by a user to said ‘present’ segment; wherein said ‘present’ segment include at least one item vertically arranged according to user's definition with or without due date or time assignment; wherein the number of items that presented in said ‘present’ segment is predefined; further wherein the representation of an item would be presented higher for item scheduled to future date or less important than the item beneath it; further wherein two icons are presented next to each item, representing buttons for deletion of the item and to reassigning of the item to the ‘past’ segment; and wherein said representation of an item may be dragged by a user to said ‘present’ segment or in order to change positions with other ‘present’ items; wherein said ‘past’ segment include at least one item vertically arranged according to the date and time in which a user reassigned said item to the ‘past’ segment; and wherein said user may zoom in and out and scroll up, down, left and right.

It is further within provision of the invention to be wherein said ‘present’ segment comprise of an empty item allowing said user to directly enter an item to said segment.

It is further within provision of the invention to be wherein said ‘future’ segment comprise of an empty item allowing said user to directly enter an item to said segment.

It is further within provision of the invention to be wherein said ‘past’ segment comprise of an empty item allowing said user to directly enter an item to said segment.

It is further within provision of the invention to be wherein said user receive or send an invitation from or to another user and wherein said invitation is presented in said ‘future’ segment with or without date and time assignment.

It is further within provision of the invention to be wherein ‘future’ segment item for which the user has assigned date is automatically moved to said ‘present’ segment according to predefined criteria.

It is further within provision of the invention to be wherein one or more items are grouped in a visual representation and having a visual title.

It is further within provision of the invention to be wherein said user may change items visual features.

It is further within provision of the invention to be wherein said ‘future’ segment branch looking representation comprise more than one end item.

It is further within provision of the invention to further comprise a title presented for said branch.

It is further within provision of the invention to be wherein said ‘future’ segment is presented and scrollable in 3 dimensions.

It is further within provision of the invention to be wherein said user may drag and drop items from the ‘future’ and ‘present’ segments and locate them in a different location.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1-11 illustrates examples of the user interface of the invention.

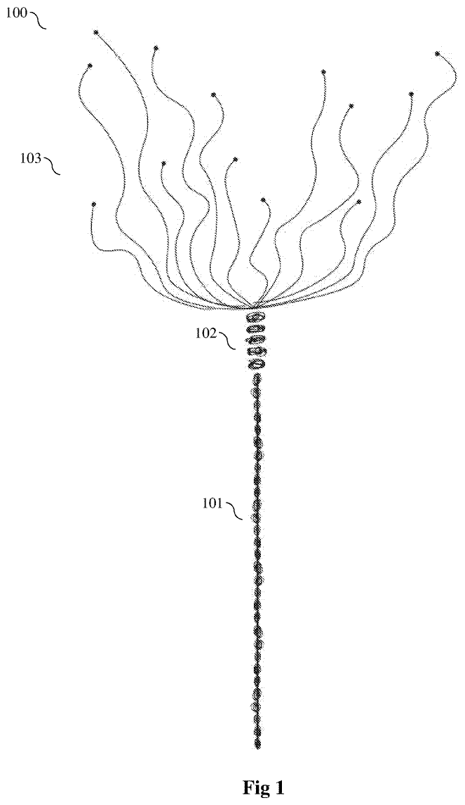

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for calendar and tasks management user interface.

In the following detailed description, numerous specific details are set forth in order to provide a thorough understanding of embodiments of the present invention. However, those skilled in the art will understand that such embodiments may be practiced without these specific details. Just as each feature recalls the entirety, so may it yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term ‘plurality’ refers hereinafter to any positive integer (e.g, 1, 5, or 10).

The invention relates to systems and methods for allowing a user interface for calendars and tasks management.

Generally speaking, the system and method may allow a user to view, manage, plan and review his or her time and actions in a new way.

One of the basic principle in the Aristotle way of thinking is a correct representation of reality, including time. One might argue that human perceive and divide ‘time’ to past, present and future as each has meaning and consequences for us. The future has options for us, the present is where can act, and we can reflect on the past but we cannot change it.

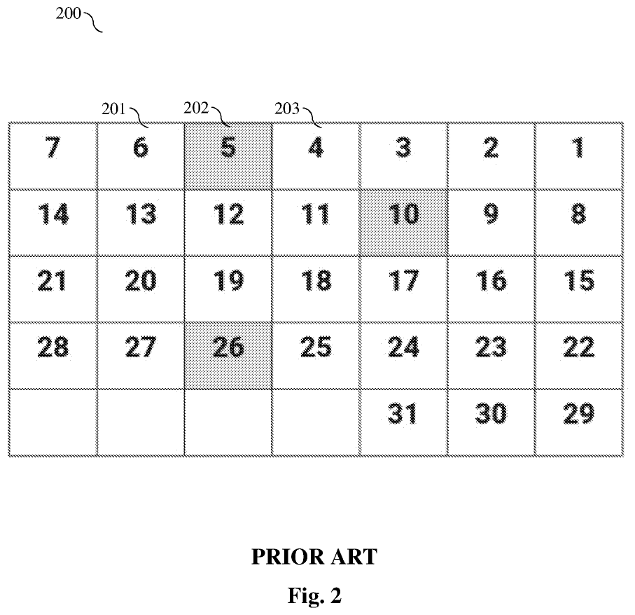

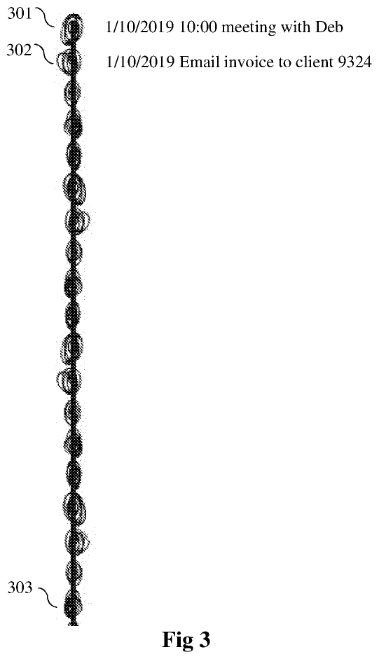

As can be seen in FIG. 2, which depict an example of prior art 200 calendar, current day calendars does not, in most cases, show a very clear and strict representation of past 201, present 202 and future 203. In most cases, the present day may be highlighted in one way or the other and in some cases, the past may be greyed out or otherwise less visible—but the basic representation would still remain the same.

While the past is unchangeable, what happened—happened and cannot be changed it is still, even now days, presented in a similar why to the present and future parts of a calendar.

The future, in current calendars and tasks softwares is very strict and require either to choose a specific date and time or “piled” in a list of things to be done.

The current invention discloses a new method for user interface and changes in calendar, tasks and alike softwares.

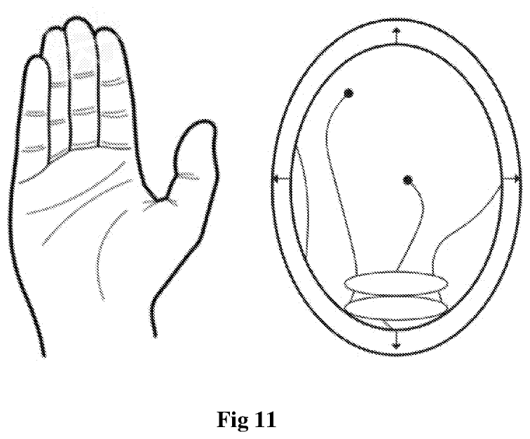

In some embodiments of the invention, a method comprising an electronic device with a display (which may be any computing device known in the art, such a computer, smart phone, tablet, dedicated device as depicted in FIG. 11, etc.) which may comprise one or more input devices, processors and memory. Which may be storing one or more programs running on the computing device, either directly or as web/cloud service and may include the relevant instructions for executing the invention's method.

The user interface of the current invention may display a calendar and tasks management software user interface 100 that may contain and present calendar items and task items without separation. In an embodiment of the invention the user interface nay not have a “meeting” section and a “to do list” section, both kind of items would be represented in a similar or identical way. In some of the embodiments pf the invention, features of the visual representation of each may be different to represent items with defined date and/or time assigned to them and other without user defined date and/or time assign to them. Such visual representation features may be, for example, color, font, size, icon, etc. but such are not limited to the features listed.

In an embodiment of the invention, the user interface may include three main segments, representing the ‘past’ 101, the ‘present’ 102 and the ‘future’ 103. Those segments may be displayed vertically, i.e. ‘past’ segment may be presented in the lower part of the user interface and may have a single connecting point to the ‘present’ segment which may be located in the middle section. The ‘present’ segment is connected to the ‘future’ segment from the top of the items of the ‘present’ segment from which multiple connections may be present to items in the ‘future’ segment.

Since most humans consider the past linear, meaning that the past contained one event after the other, particularly in manner of actions or events in which a specific person was involved in, then in some embodiments of the invention, the ‘past’ segment which may include one or more items that may be arranged vertically, having one item above the older item. The order of the items, as in some embodiments of the invention, may be arranged according to the date and time in which the user reassigned them to the ‘past’ segment. For example, a user had two items in the ‘present’ segment: “10:00 meeting with Deb” and “Email invoice to client 9324”. The user used the user interface to reassign item “10:00 meeting with Deb” 301 to the past, indicating that this item was done and then dragged item Email invoice to client 9324″ 302 to the past segment, to indicate the same. Now the past segment contains two new items which were removed from the ‘present’ segment, the lower item would be “10:00 meeting with Deb” item and above it would be item “Email invoice to client 9324”.

Many current days “to do lists” uses a symbolically destructive method of marking that a task has been performed—using a strike thought line which diminish the work and effort that was put into completing the tasks:

In further embodiments of the invention, the user interface (in the ‘past’, ‘present’ and ‘future’ segments) may comprise of the item's full or partial text while in other embodiments of the invention the user interface may comprise an icon, a symbol, a hyperlink, full text or partial text or any combination thereof.

In further embodiments of the invention, the ‘past’ segment may further comprise of an empty item 303 allowing the user to directly enter an item.

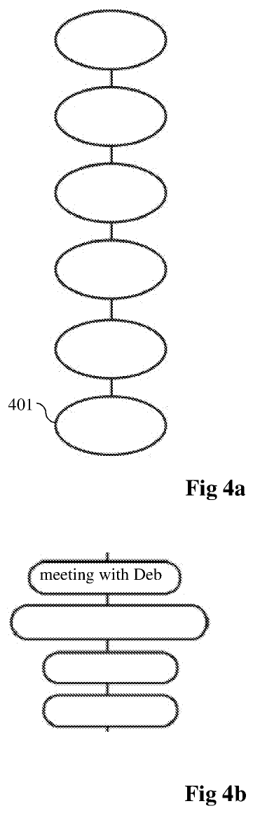

In some embodiments of the invention, as depicted in FIGS. 4a and 4b, unlike the ‘future’ and ‘past’ segments, the ‘present’ segment may include a limited number of items as predefined by the user or by the software. In further embodiments of the invention, the software may employ learning procedure to learn the average number of items that a specific user or a group of users may handle per time unit and limit accordingly.

The user interface may receive items that have or that does not have a defined date and time assigned to them. For example, a user may add “Do laundry” to the present, which may be in some embodiment a reference for “Today” while in other embodiments such may be reference for other time units, such as “This week”, “In the next 3 hours” or even “Soon”. In a different example, the user may add “Do laundry” and define the item for the date of today at 17:00.

In case of adding an item to list comprising only items with defined date and time, the item may be presented in its correct location, i.e. above an item due before it and below an item due after it. In case of mixed list or list that contain only items that has no date and time assigned to them, the user interface may add it chronically or allow the user to choose its location. In further embodiments of the invention, the user may, in any case, drag and drop an item wherever the user wishes to place it, for example, while takin into account the importance of the content of the item to the user.

In some embodiments of the invention, two icons may be presented to the user representing buttons for deletion of the item and to reassigning of the item to the ‘past’ segment. In further embodiments of the invention, the user may drag and drop am item in the ‘past’ segment or in a predefined area representing deletion zone (for example, a trash can icon, as known in the art or otherwise).

In further embodiments of the invention, the ‘present’ segment may further comprise of an empty item 401 allowing the user to directly enter an item.

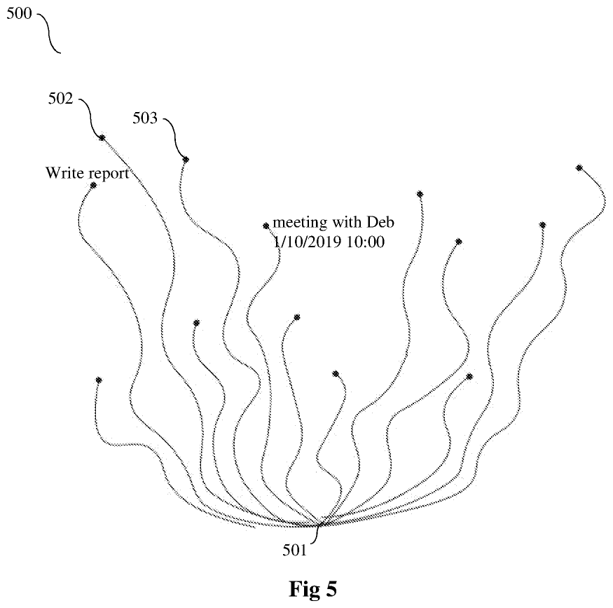

The user interface, as in some embodiments of the invention, may comprise the ‘future’ segment as depicted in FIG. 5.

The segment 500 may comprise of branch like connecting indicators originated from the top of the ‘present’ segment 501 and ending with an item 502.

The vertical arrangement of the ‘future’ segment may, as in some embodiments, be similar to the arrangement of the ‘present’ segment, i.e. with the optional adding of a due date and time and the arrangement accordingly. In embodiments of the invention, the user may decide not to add due date and time in some or all of the items.

However, the horizontal arrangement of item may be controlled completely by the user which may drag and drop any item in any location and change any placement of items both horizontally and vertically.

As in the ‘past’ and ‘present’ segments, the higher the user place an item the more “futuristic” it is for the user.

Similarly to the ‘present’ segment, the user interface may contain two icons one for the reassigning of the item to the ‘present’ segment and the other for deletion. Same may be regarding the option to drag and drop items.

In further embodiments of the invention, the ‘future’ segment may further comprise of an empty item 503 allowing the user to directly enter an item.

In some embodiments of the invention, in case a user assigned a due date and time for an item, such may be moved automatically to the ‘present’ segment according to the user's or predefined logic or criteria. For example, in a case a user assigned a date and time for “Meeting with Moses”, such may be moved to the ‘present’ segment on the date of the event using an example of predefine logic or may be override by the user to appear 3 days ahead of the date in the ‘present’ segment.

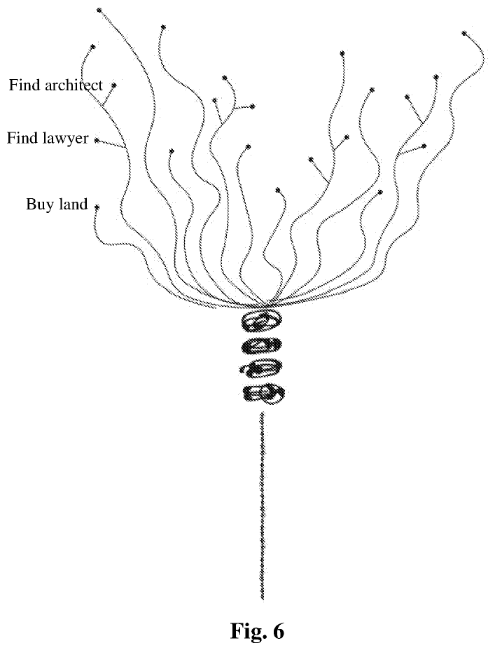

In further embodiments of the invention, as depicted in FIG. 6, each branch in the ‘future’ segment may have more than one end. Such may allow the user to visually group tasks, actions, meetings and alike that leads to a certain goal or achievement. For example, a user that wishes to buy land and build a hose may add items relevant to such—“find land”, “talk to lawyer about land taxes”, “find architect”, etc. In further embodiments of the invention, the user may assign a title to a branch which may be presented in the user interface.

In some embodiments of the invention a group of item, either on the ‘past’, ‘present’ or ‘future’ segments, may be grouped using a visual representation such as a shape surrounding the grouped items. In further embodiments of the invention, the user may assign a title to a group which may be presented in the user interface.

In further embodiments of the invention, the user may change the visual features of items.

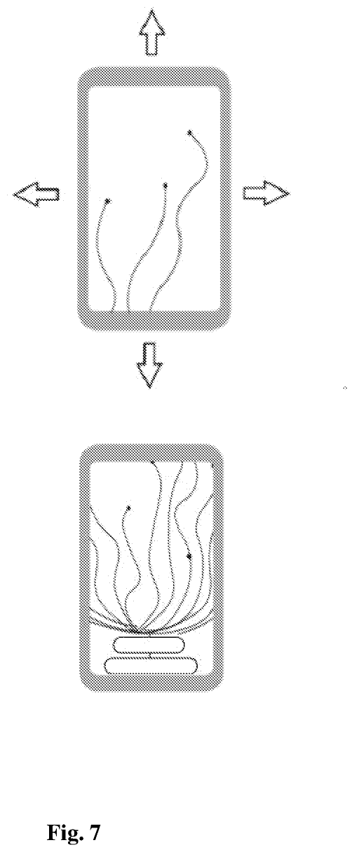

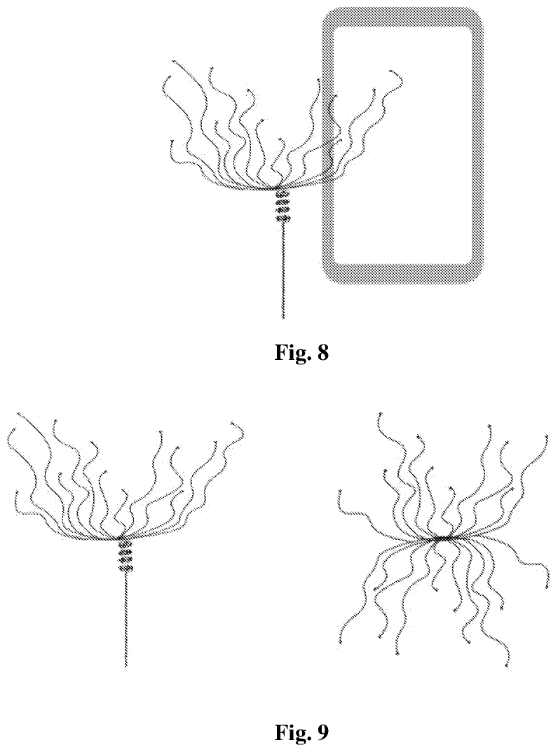

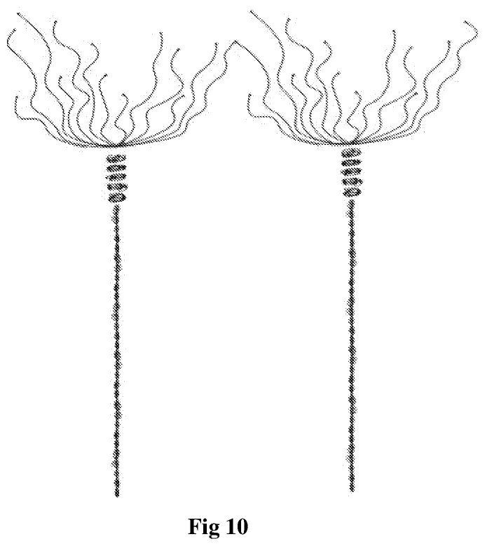

As can be appreciated, such user interface may in some cases require a large displaying area which cannot be found on some or all devices. Hence, the user interface will allow zooming in and out as well as scrolling to the sides, as depicted in FIG. 7 and FIG. 8.

In further embodiments of the invention, the ‘future’ segment may be represented and scrollable in three dimensions as depicted in FIG. 9. If further embodiments of the invention, virtual reality devices may be used to browse the items.

In some embodiments of the invention, a shared user interface may be allowed between users in a fully or partial way. For example, a partial sharing may be achieve using sending invitations between users creating a connection between two (or more) ‘future’ segments, for example when setting up a meeting between two users or when a single user has more than one calendar and the user wishes to connect certain events in the ‘future’, ‘present’ or ‘past’ segments.

In some embodiments of the invention, a user may be able to filter the items that presented using the features the users assigned to the items, using searches and other methods as known in the art.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A method comprising:
at an electronic device with a display, at least one input device, one or more processors and memory storing one or more programs configured to be executed by the one or more processors, the one or more programs including instructions for:
displaying a calendar and tasks management user interface of a calendar and tasks management application, wherein calendar items and task items are presented without separation, the user interface includes three main segments, representing ‘past’, ‘present’ and ‘future’ and displayed vertically wherein said ‘past’ segment has one connecting point to said ‘present’ segment and wherein said ‘present’ segment has at least one connecting point to said ‘future’ segment;
wherein said ‘future’ segment include more than one item vertically and horizontally arranged, in at least two parallel branches, according to user's definition with or without due date or time assignment;
wherein said items presented at the end of a branch like representation originated from said connection to said ‘present’ segment;
further wherein the representation of an item would be presented higher for item scheduled to future date or less important than the item beneath it;
further wherein two icons are presented next to each item, representing buttons for deletion of the item and to reassigning of the item to the ‘present’ segment; and
wherein said representation of an item may be dragged by a user to said ‘present’ segment;
wherein said ‘present’ segment include at least one item vertically arranged according to user's definition with or without due date or time assignment;
wherein the number of items that presented in said ‘present’ segment is predefined;
further wherein the representation of an item would be presented higher for item scheduled to future date or less important than the item beneath it;
further wherein two icons are presented next to each item, representing buttons for deletion of the item and to reassigning of the item to the ‘past’ segment; and
wherein said representation of an item may be dragged by a user to said ‘present’ segment or in order to change positions with other ‘present’ items;
wherein said ‘past’ segment include at least one item vertically arranged according to the date and time in which a user reassigned said item to the ‘past’ segment; and
wherein said user may zoom in and out and scroll up, down, left and right.

2. The method of claim 1 wherein said ‘present’ segment comprise of an empty item allowing said user to directly enter an item to said segment.

3. The method of claim 1 wherein said ‘future’ segment comprise of an empty item allowing said user to directly enter an item to said segment.

4. The method of claim 1 wherein said ‘past’ segment comprise of an empty item allowing said user to directly enter an item to said segment.

5. The method of claim 1 wherein said user receive or send an invitation from or to another user and wherein said invitation is presented in said ‘future’ segment with or without date and time assignment.

6. The method of claim 1 wherein ‘future’ segment item for which the user has assigned date is automatically moved to said ‘present’ segment according to predefined criteria.

7. The method of claim 1 wherein one or more items are grouped in a visual representation and having a visual title.

8. The method of claim 1 wherein said user may change items visual features.

9. The method of claim 1 wherein said ‘future’ segment branch looking representation comprise more than one end item.

10. The method of claim 9 further comprising a title presented for said branch.

11. The method of claim 1 wherein said ‘future’ segment is presented and scrollable in 3 dimensions.

12. The method of claim 1 wherein said user may drag and drop items from the ‘future’ and ‘present’ segments and locate them in a different location.
